(19) United States
(12) Patent Application Publication
(10) Pub. No.: US 2026/0097347 A1
(43) Pub. Date: Apr. 9, 2026

(54) FLAT-FILTER FILTER ELEMENT HAVING AT LEAST TWO FILTER-MATERIAL BODIES, FILTER SYSTEM, AND USE OF A FLAT-FILTER FILTER ELEMENT

(71) Applicant: MANN+HUMMEL GmbH, Ludwigsburg (DE)

(72) Inventor: Daniel SCHMID, Sachsenheim (DE)

(21) Appl. No.: 19/406,395

(22) Filed: Dec. 2, 2025

Related U.S. Application Data
(63) Continuation of application No. PCT/EP2024/063496, filed on May 16, 2024.

(30) Foreign Application Priority Data
Jun. 6, 2023 (DE) 10 2023 114 803.6

(51) Int. Cl. B01D 46/64; B01D 46/00; B01D 46/52

(52) U.S. Cl. CPC B01D 46/64; B01D 46/0013; B01D 46/0036; B01D 46/521; B01D 2265/04; B01D 2267/40; B01D 2271/022

(57) ABSTRACT

A filter element for filtering a fluid has at least two areal filter medium bodies arranged axially to be flowed through sequentially by the fluid. The filter medium bodies include an outermost downstream filter medium body and an outermost upstream filter medium body. The outermost downstream and outermost upstream filter medium bodies are arranged radially inside a frame element. The outermost downstream filter medium body has a circumferential downstream molded element and is connected by the circumferential downstream molded element to the frame element. The outermost upstream filter medium body has a circumferential upstream molded element and is connected by the circumferential upstream molded element to the frame element. The circumferential upstream molded element is connected to an upstream frame element end. The circumferential downstream molded element is connected to a downstream frame element end. The filter element is arranged in a filter housing of a filter system.

### CROSS-REFERENCE TO RELATED APPLICATIONS

This application is a continuation application of international application No. PCT/EP2024/063496 having an international filing date of May 16, 2024, and designating the United States, the international application claiming a priority date of June 6, 2023, based on prior filed German patent application No. 102023114 803.6, the entire contents of the aforesaid applications being incorporated herein by reference.

### BACKGROUND

The invention concerns a flat-filter filter element for filtering a fluid, for example for filtering air, for a filter system, for example for an air filter system of a fuel cell system, as well as a filter system for filtering a fluid, for example for filtering air, for example of a fuel cell system, with such a flat-filter filter element, and a use of a flat filter element in a filter system.

Fuel cell systems often require a particle filter and an adsorption filter in order to filter particles as well as harmful gases out of the intake air. The filter elements are often configured as flat filters, for example, but other filter element shapes are also available.

DE 102009016739 A1 discloses a housing for filtering the intake air of a fuel cell, including a housing bottom part and a housing top part which together delimit a chamber. The chamber is divided by at least one filter element into a raw air chamber and a clean air chamber. The housing bottom part as well as the housing top part each have assigned thereto an air passage socket for guiding intake air into the chamber or out of the chamber. In this context, the filter element is at least partially embedded in a seal material.

EP 3520878 B1 discloses a filter element for filtering interior air with at least three filter layers, wherein the filter layers are arranged in a frame and the frame is assembled of extruded profile strips. In this context, the first filter layer is configured as a prefilter, the second filter layer as a fine filter, and the third filter layer as an adsorption filter. In the frame, a region is provided for each filter layer. Furthermore, each profile strip includes between second filter layer and third filter layer a projecting step which serves for separating the second filter layer from the third filter layer in the region of the frame.

US 2015/0273985 A1 discloses an interior air filter element which, as an exchangeable filter element for an interior air filter for a driver cabin of agricultural and work machines, for example with sprinkling and spraying devices for plant protection or fertilizers, may be installed in a vehicle-fixed filter housing. The interior air filter element includes a prefilter layer, an adsorption filter layer, a fine filter layer, for example for separating aerosols, as well as a filter element frame. The filter element frame determines by its geometry a flow direction along which the intake air flows through the aforementioned filter layers. The filter element frame includes two regions. In the first region of the filter element frame, a first effective cross section surface is provided with regard to the flow of the intake air through the filter layers. A corresponding second effective cross section surface is provided in the second region. The first region and the second region are separated by a circumferential seal. The circumferential seal serves for separation of the raw side of the interior air filter element from the clean side when the interior air filter element is installed in the filter housing of the interior air filter. The first region is arranged upstream in regard to the seal, the second region is arranged downstream in regard to the seal. In this context, the second effective cross section surface area amounts to only a fraction of the first effective cross section surface area. The filter layers are fastened by means of adhesive spots in the filter element frame.

US 2021/0276401 A1 discloses a vehicle interior filter system which includes a filter module and a further filter module that is arranged downstream of the filter module. Each filter module includes one or several filter elements. The filter elements of the filter module are folded at a first fold distance and include a gas filter element. The filter elements of the further filter module are folded at a second fold distance and include a particle filter element. In this context, the second fold distance is smaller than the first fold distance. The filter elements of a filter module are arranged in a frame, respectively. The frame is sealed by a seal against a module housing in which the filter module is arranged. The module housing, when installed in a filter housing, is sealed by an end face seal in relation to the filter housing.

### SUMMARY

It is an object of the invention to provide a service-friendly and cost-efficient flat-filter filter element with at least two filter medium bodies for filtering a fluid, for example for filtering air, for a filter system, for example for an air filter system of a fuel cell system.

A further object is to provide a filter system for filtering a fluid, for example for filtering air, for example of a fuel cell system, with such a service-friendly and cost-efficient filter element.

A further object is to provide a use of a flat-filter filter element in a filter system.

The aforementioned object is solved according to an aspect of the invention by a flat-filter filter element for filtering a fluid, for example for filtering air, for a filter system, for example for an air filter system of a fuel cell system, including an array of at least two areal filter medium bodies arranged adjacent to each other in an axial direction and arranged so as to be flowed through sequentially by the fluid in the axial direction, wherein at least the outermost downstream arranged one of the filter medium bodies and at least the outermost upstream arranged one of the filter medium bodies are arranged at least partially in axial direction radially inside of a circumferential frame element, wherein the outermost downstream filter medium body, by means of a circumferential downstream molded element, and the outermost upstream filter medium body, by means of a circumferential upstream molded element, are connected to the frame element, wherein the upstream molded element is connected to an upstream end of the frame element and the downstream molded element is connected to a downstream end of the frame element.

The further object is solved by a filter system for filtering a fluid, for example for filtering air, for example of a fuel cell system, including a filter housing with a fluid inlet and a fluid outlet and including at least one flat-filter filter element which is arranged between the fluid inlet and the fluid outlet, wherein a seal surface of a first housing part of the filter housing contacts the molded element of the flat-filter filter element, and wherein a housing wall of a second housing part of the filter housing is pressed seal-tightly against the molded element at a side of the molded element facing away from the seal surface.

The further object is solved by a use of a flat-filter filter element in a filter system for filtering a fluid, for example for filtering air, for example for an air filter system of a fuel cell system.

Embodiments and advantages of the invention are apparent from the further description and the accompanying drawings.

According to an aspect of the invention, a flat-filter filter element for filtering a fluid, for example for filtering air, for a filter system, for example for an air filter system of a fuel cell system, is proposed, including an array of at least two areal filter medium bodies arranged adjacent to each other in an axial direction and arranged to be flowed through sequentially by the fluid in the axial direction. At least the outermost downstream arranged one of the filter medium bodies and at least the outermost upstream arranged one of the filter medium bodies are arranged at least partially in axial direction radially inside of a circumferential frame element. In this context, the outermost downstream filter medium body, by means of a circumferential downstream molded element, and the outermost upstream filter medium body, by means of a circumferential upstream molded element, are connected to the frame element. The upstream molded element is connected to an upstream end of the frame element and the downstream molded element is connected to a downstream end of the frame element.

The proposed filter element may be used for the intake air of fuel cells. An adsorption of harmful substances and a particle filtration may be realized in different filter medium bodies, respectively. The two filter medium bodies, in turn, may be introduced, when producing the filter element, from oppositely positioned sides into the frame element, for example, a plastic material frame element. In this way, a fixed connection of the respective filter medium body to the frame element may be easily produced, respectively. The sealing action to the housing parts of the filter housing is realized by a seal which is attached fixedly to the separate frame element. In this context, the seal element is expediently formed by the downstream molded element which at the same time constitutes the fixed connection between the downstream filter medium body and the frame element.

The frame element may be produced by a conventional plastic material injection molding process in which liquefied plastic material is injected under pressure into a mold and hardened.

The upstream filter medium body is closer to the inflow side of the filter element than the downstream filter medium body which is closer to the outflow side of the filter element.

The molded element may be produced by means of a plastic material molding process or plastic material foaming process in a suitable mold, for example, from the molding material polyurethane (PUR). The molding material may be configured as a hard foam or soft foam.

The seal may be designed such that a counter force of the housing parts provides the sealing action. The seal may then be compressed between the frame element and the housing parts.

The filter element includes thus a frame element as carrier for the two filter medium bodies with a molded element. The two filter medium bodies are fixedly connected by two separate molded elements to the frame element.

In the proposed flat-filter filter element, both filter medium bodies for the two filtration stages are arranged in the form of flat filter medium bodies one after another in flow direction.

The two filter medium bodies may be configured as folded bellows, wound body, loose fill (primarily for adsorption of harmful gases), coated honeycomb body (primarily for adsorption of harmful gases) or combinations thereof. The height of the filter medium bodies in axial direction may be designed differently. The flow through the filter element is such that the filter medium body embodied as a particle filter is always flowed through first. A sealing action of the filter element in relation to the filter housing may be realized in axial direction.

Particles as well as harmful gases may be filtered out of the intake air in this manner, for example, in fuel cell systems.

The installation space which is available may thus be utilized better. This results in advantages in relation to adsorption capability, dust capacity, degree of separation, and pressure loss of the filter system.

According to an embodiment of the filter element, the outermost downstream filter medium body at one of its outer edges, for example its downstream outer edge, may be connected by means of the circumferential downstream molded element to the frame element. In this way, a fixed connection to the frame element may be realized which, at the same time, may be configured as a seal element for a sealing action in the filter housing.

According to an embodiment of the filter element, the downstream axial end of the frame element, for example its end face, may be enclosed at least partially by the downstream molded element. As an alternative or in addition, the upstream axial end of the frame element, for example its end face, may be enclosed at least partially by the upstream molded element. In this way, a fixed connection of the molded elements to the frame element may be achieved which, at the same time, may be configured as a seal element for a sealing action in the filter housing.

According to an embodiment of the filter element, the frame element may include at its downstream end an outwardly folded collar. In this context, the collar may be for example embedded in the downstream molded element. In this way, a fixed interlocking of the molded element with the frame element results. Also, filter medium bodies with higher weight and larger expansion are imparted in this way with sufficient stability for mounting in the filter housing.

According to an embodiment of the filter element, the frame element may include a circumferential rim at its upstream end. For example, in this context, the circumferential rim may include a groove which is oriented in axial direction away from the downstream molded element. By means of the groove for receiving the molding material, the upstream filter medium body may be connected to the frame element in a reliable manner by means of the upstream molded element.

According to an embodiment of the filter element, the groove may be configured as an integrated mold for the upstream molded element. For example, the groove may project into the interior of the frame element. In this way, the molding process when producing the upstream molded element may be realized in an expedient manner. Tool costs for an additional mold may be saved. The molded element does not occupy space at the exterior side of the frame element so that the filter element may be inserted into the filter housing.

According to an embodiment of the filter element, the upstream filter medium body may project largely out of the frame element in axial direction and be embedded with its downstream outer edge in the upstream molded element. In this way, the frame element may be kept relatively short in axial direction because it must include essentially only the height of the downstream filter medium body. In this manner, plastic material for the frame element may be saved.

According to an embodiment of the filter element, the upstream filter medium body may project largely into the frame element in axial direction and with its upstream outer edge be embedded in the upstream molded element. In this embodiment, the upstream filter medium body is covered and protected in lateral direction by the frame element. The filter element represents thus a compact unit which may be handled in an advantageous manner.

According to an embodiment of the filter element, the frame element in the region of the upstream and/or downstream molded element may have gaps for interlocking at its circumference. Due to the gaps for interlocking with the molding material of the molded element, a reliable and permanent connection between the molded elements and the frame element may be realized.

According to an embodiment of the filter element, at least one reinforcement element may be arranged areally between the outermost upstream and the outermost downstream filter medium bodies. For example, between the outermost upstream and the outermost downstream filter medium bodies, an expansive reinforcement grid and/or one or a plurality of glue beads may be arranged. Especially in case of very large areally expansive filter elements, the reinforcement element may contribute to a reinforcement of the entire filter element. In addition, the upstream filter medium body may be supported against the flow pressure of the fluid to be filtered in this way.

According to an embodiment of the filter element, the at least one reinforcement element may be configured as a reinforcement grid which is supported at the frame element. For example, the reinforcement grid may be connected to the frame element in this context. For example, the reinforcement grid may be embodied as one piece together with the frame element. In this manner, the reinforcement element may contribute to the stability of the entire filter element, for example in case of large area filter elements.

According to an embodiment of the filter element, at least one of the filter medium bodies may include at its outer circumference a circumferential lateral strip which at least partially is embedded in the correlated molded element. The lateral strip seals the filter medium body at the side walls which is for example beneficial in case of filter medium bodies in the form of folded filter bellows or loose fills. By the integration in the molded element, a reliable sealing action of the filter medium body along the flow path may be realized. The lateral strip, for example, may be included of a nonwoven material, for example a filter nonwoven, filter fabric or laid filter material. The nonwoven material of the lateral strip may include for example a reduced air permeability compared to a filter medium of the filter medium body and/or a higher bending stiffness compared to the filter medium of the filter medium body.

According to an embodiment of the filter element, the outermost downstream filter medium body may include an additional filter layer at its downstream side, wherein the additional filter layer may be at least partially embedded in the downstream molded element. In this way, for example an escape of adsorption particles from the downstream filter medium body due to the fluid flow may be prevented. As embodiments for the additional filter layer, filter media on the basis of cellulose fibers and/or synthetic fibers, for example nonwoven materials and/or filter membranes, are conceivable.

The filter medium bodies may be configured as folded filter bellows and/or as wound body and/or as loose fill and/or as coated honeycomb body.

According to an embodiment of the filter element, the outermost upstream filter medium body may be configured as a particle filter. As an alternative or in addition, the outermost downstream filter medium body may be configured as an adsorption filter. The particle filter may be configured, for example, of cellulose. The adsorption filter may be configured as an active carbon filter and/or as an ion exchanger.

According to an embodiment of the filter element, the downstream molded element may be configured as a seal element for sealing, for example in axial direction, between a raw side and a clean side when the filter element is installed as intended in a filter housing of the filter system. For example, in this context the molded element may be arranged radially outside of the at least two filter medium bodies and may be configured for sealing between a first housing part and a second housing part of the filter housing of the filter system. In this manner, the molded element may fulfill several functions and may be configured to connect the downstream filter medium body as well as to seal the filter element in relation to the filter housing. Due to the arrangement outside of the two filter medium bodies, the molded element may be compressed effectively between the two housing parts and thus ensure the sealing action between raw side and clean side of the filter system as well as the sealing action in relation to the environment.

According to an embodiment of the filter element, at least one of the two filter medium bodies may be configured as a folded filter bellows, wherein end face edges of folds of the at least one of the two filter medium bodies may be sealed by an end face edge bonding. In this context, the end face edge bonding may be embedded at least partially in the downstream and/or upstream molded element. In this manner, a reliable lateral sealing action of the filter medium body by means of the end face edge bonding and connection to the molded element are ensured.

According to a further aspect of the invention, a filter system for filtering a fluid, for example for filtering air, for example of a fuel cell system, is proposed, including a filter housing with a fluid inlet and a fluid outlet and including at least one flat-filter filter element which is arranged between the fluid inlet and the fluid outlet. In this context, a seal surface of a first housing part of the filter housing contacts a molded element of the flat-filter filter element and a housing wall of a second housing part of the filter housing is seal-tightly pressed against the molded element at a side of the molded element facing away from the seal surface.

The proposed filter system including a flat-filter filter element may be used for the intake air of fuel cells. The adsorption and particle filtration may be realized in different filter medium bodies. The two filter medium bodies of the filter element, in turn, are introduced from oppositely positioned sides into the frame element, for example, a plastic material frame element. A fixed connection to the frame element may be produced in this way. The sealing action in relation to the housing parts of the filter housing is realized by a seal which is attached fixedly to the separate frame element. The seal element in this context is expediently formed by means of the downstream molded element which, at the same time, produces the fixed connection between the downstream filter medium body and the frame element.

The seal may be designed such that a counterforce of the housing parts is provided for the sealing action. The seal may then be compressed between the frame element and the housing parts.

In the proposed filter system including a flat-filter filter element, both filter medium bodies for the two filtration stages are arranged in the form of flat filter medium bodies one after another in flow direction.

The two filter medium bodies may be configured as folded bellows, wound body, loose fill (primarily for the adsorption of harmful gases), coated honeycomb body (primarily for the adsorption of harmful gases) or as combinations thereof. The height of the filter medium bodies in axial direction may be designed differently. The flow through the filter element is such that the filter medium body configured as a particle filter is always flowed through first. A sealing action of the filter element in relation to the filter housing may be realized in the axial direction.

The installation space which is available may thus be utilized better. This results in advantages in relation to the adsorption capability, dust capacity, degree of separation, and pressure loss of the filter system.

According to an embodiment of the filter system, the frame element may include a collar extending in a lateral direction and embedded in the molded element. In this context, the collar with the molded element may be compressed between the seal surface and the end of the housing wall. The molded element may be designed such that a counterforce of the housing parts ensures the sealing action. The seal may then be compressed between the frame element and the housing parts. By embedding the collar of the frame element, the molded element includes an increased stiffness and the filter element is fixed in a stable manner in the filter housing.

According to a further aspect of the invention, a use of a flat-filter filter element in a filter system, for filtering a fluid, for example for filtering air, for example for an air filter system of a fuel cell system, is proposed.

The filter element may be configured as particle filter and/or as adsorption filter, for example as active carbon filter and/or as ion exchanger. Particles as well as harmful gases may be filtered out of the intake air in fuel cell systems, for example.

### BRIEF DESCRIPTION OF THE DRAWINGS

Further advantages result from the following drawing description. In the drawings, embodiments of the invention are illustrated. The drawings and the following detailed description contain numerous features in combination. A person of skill in the art will consider the features expediently also individually and combine them to expedient further combinations.

FIG. 1 shows an isometric view of a filter system for filtering a fluid, for example for filtering air, for example of a fuel cell system, according to an embodiment of the invention.

FIG. 2 shows an isometric exploded illustration of the filter system according to FIG. 1.

FIG. 3 shows a section view of the filter system according to FIG. 1 with the filter element and with a marked detail IV.

FIG. 4 shows the enlarged detail IV according to FIG. 3 with the filter element.

FIG. 5 shows an enlarged detail of a section view of a filter system according to a further embodiment of the invention.

FIG. 6 shows a longitudinal section of a filter element according to a further embodiment of the invention with a marked detail VII.

FIG. 7 shows the enlarged detail VII of the longitudinal section of the filter element according to FIG. 6.

### DETAILED DESCRIPTION

In the drawing figures, same or same-type components are identified with like reference characters. The drawing figures show only examples and are not to be understood as limiting.

Directional terminology used in the following with terms such as “left”, “right”, “top”, “bottom”, “in front of”, “behind”, “thereafter” and the like serve only for a better understanding of the drawing figures and is not intended to represent a limitation of the generality. The illustrated components and elements, their interpretation and use may vary in the context of considerations of a person of skill in the art and be adapted to the respective applications.

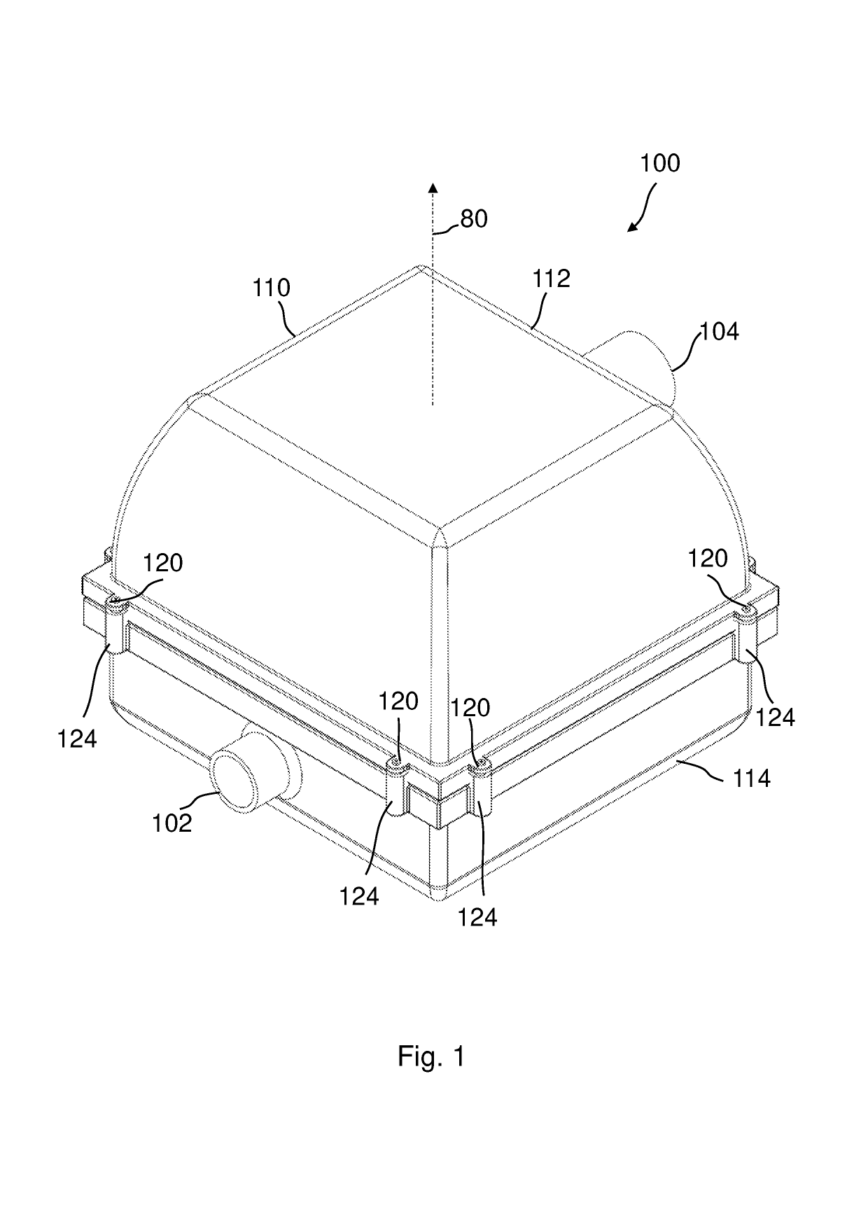

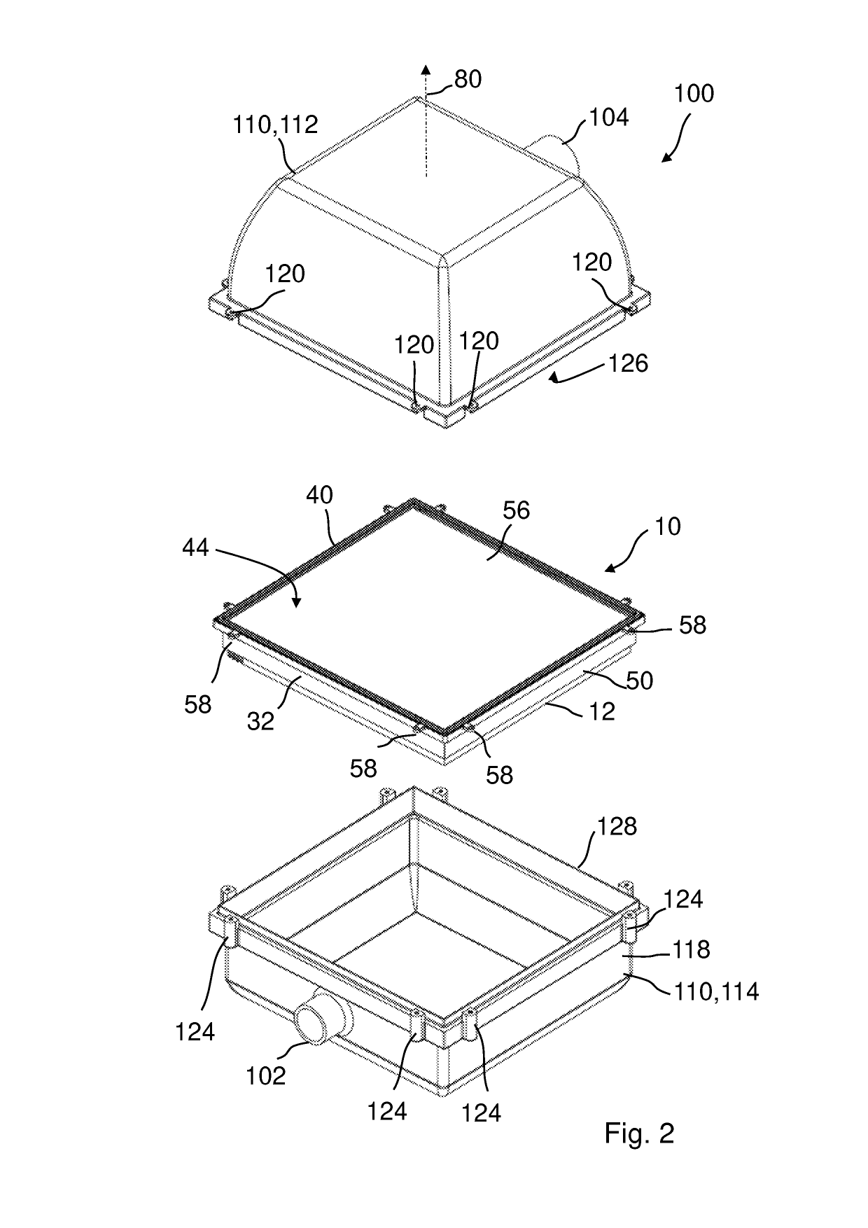

FIG. 1 shows an isometric view of a filter system 100 for filtering a fluid, for example for filtering air, for example of a fuel cell system, according to an embodiment of the invention. FIG. 2 shows an isometric exploded view of the filter system 100.

The filter system 100 comprises a filter housing 110 with a fluid inlet 102 and a fluid outlet 104 and comprises at least one flat-filter filter element 10 which is arranged between the fluid inlet 102 and the fluid outlet 104. The fluid inlet 102 is arranged in a second housing part 114 and the fluid outlet 104 in a first housing part 112.

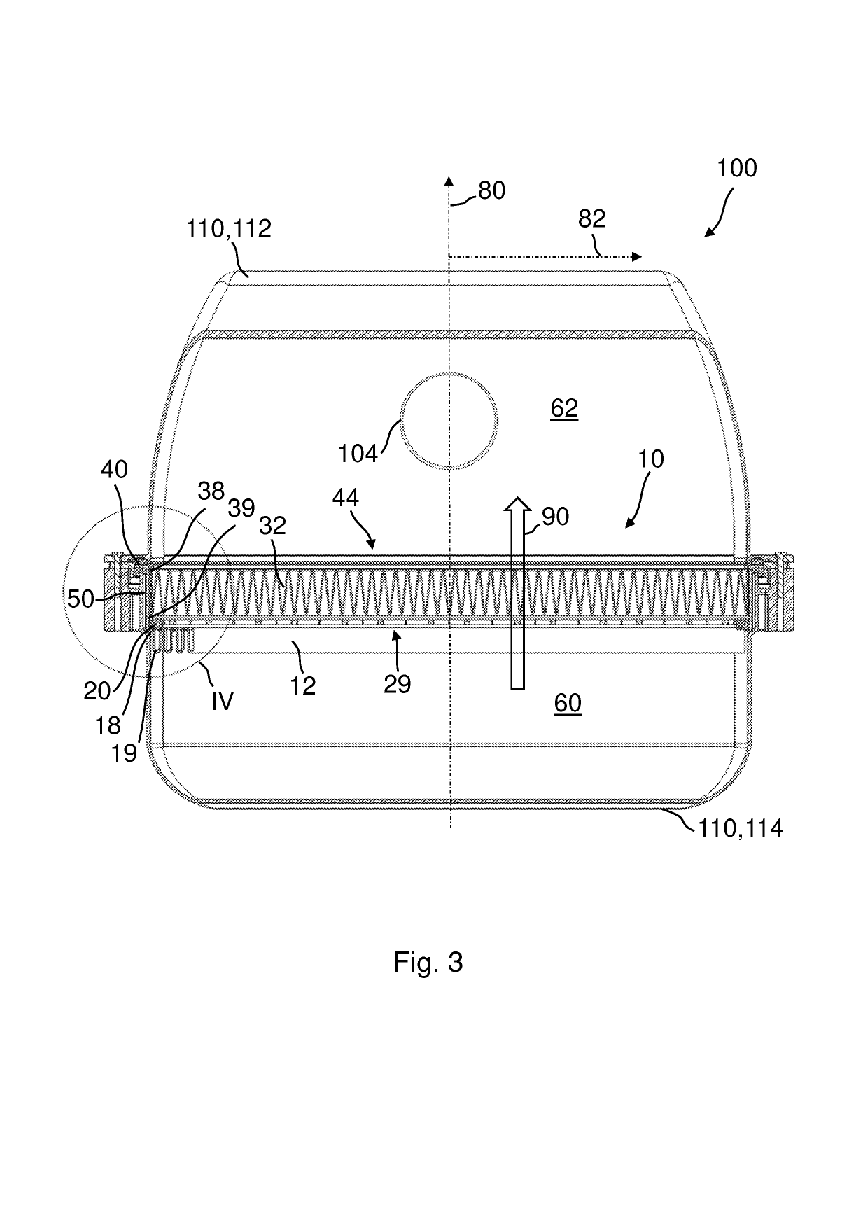

The filter element 10 comprises a circumferential frame element 50 (FIG. 2) with a circumferential molded element 40 configured as an axial seal element. The molded element 40 seals the interior of the filter housing 110 in relation to the environment when the filter element 10 is arranged as intended in the second housing part 114 and filter housing 110 is closed by the first housing part 112. At the same time, the molded element 40 seals a raw side 60 in the interior of the filter housing 110 in relation to a clean side 62 (FIG. 3).

The outflow side 44 of the filter element 10 is oriented in the direction of the fluid outlet 104 toward the first housing part 112.

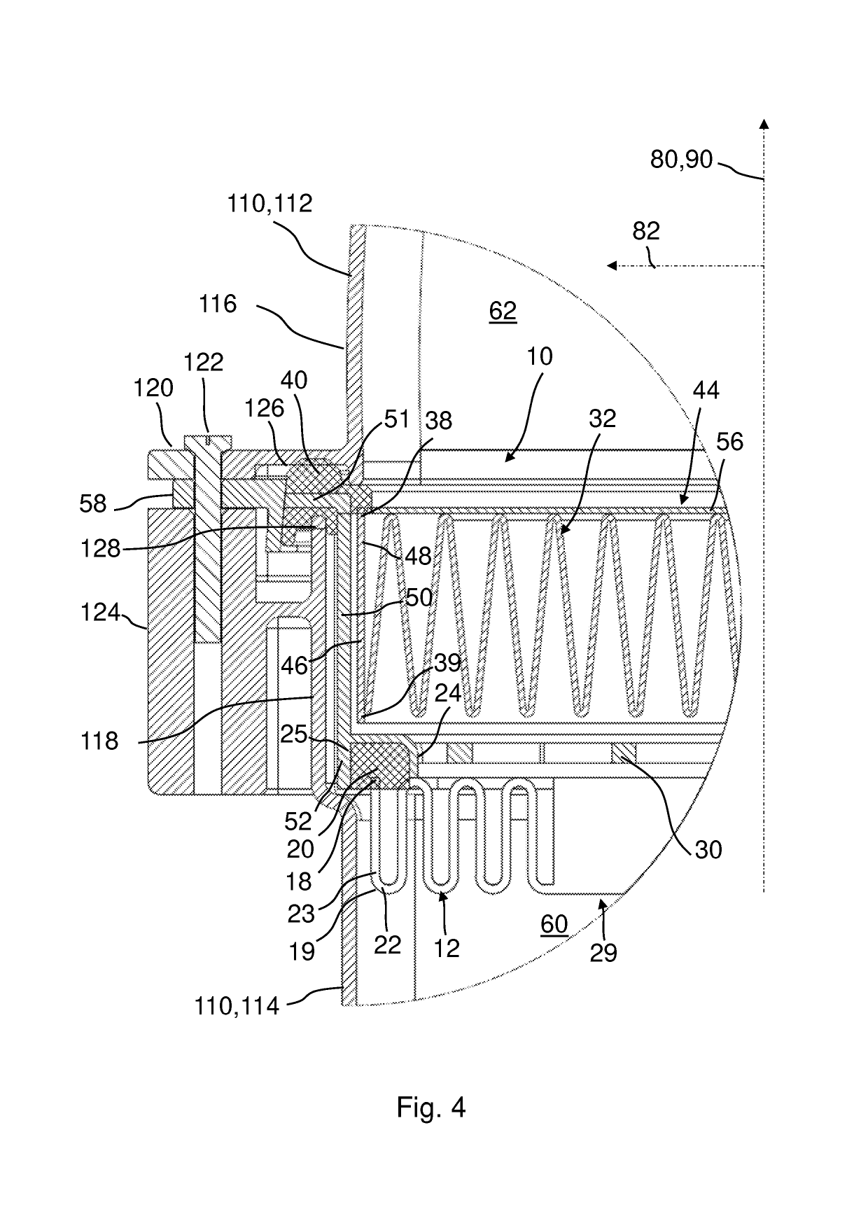

When the filter element 10 is inserted, screw tabs 58 of the frame element 50 of the filter element 10 are arranged between screw sleeves 124 and housing-side screw tabs 120 and fastened by means of screws 122 (FIG. 4).

In FIG. 3, a section view of the filter system 100 with the filter element 10 and marked detail IV is illustrated. FIG. 4 shows the enlarged detail IV with the filter element 10.

The flat-filter filter element 10 comprises an arrangement of two areal filter medium bodies 12, 32 neighboring each other in an axial direction 80 and arranged one after another. The two filter medium bodies 12, 32 are arranged so as to be flowed through by the fluid sequentially in the axial direction 80. The flow direction 90 is indicated by an arrow in FIG. 3. The fluid enters the filter element 10 from the inflow side 29 and exits at the outflow side 44 of the filter element 10.

The upstream filter medium body 12 is configured as a particle filter while the downstream filter medium body 32 is configured as an adsorption filter.

The filter medium bodies 12, 32 may be configured, for example, as folded filter bellows and/or as wound body and/or as loose fill and/or as coated honeycomb body. The particle filter in this context may be configured, for example, of cellulose, the adsorption filter, for example, as active carbon filter and/or as ion exchanger. In the embodiment illustrated in FIGS. 3 and 4, both filter medium bodies 12, 32 are configured as folded filter bellows.

The downstream arranged filter medium body 32 and the outermost upstream filter medium body 12 are arranged at least partially in axial direction 80 radially inside of the circumferential frame element 50.

In this context, the downstream filter medium body 32, by means of a circumferential downstream molded element 40, and the upstream filter medium body 12, by means of a circumferential upstream molded element 20, are connected to the frame element 50.

The upstream molded element 20 is connected to an upstream end of the frame element 50 and the downstream molded element 40 is connected to a downstream end of the frame element 50.

In this context, the upstream and/or downstream axial end of the frame element 50, for example its end face, as seen in FIG. 4, may be embedded at least partially by the upstream or the downstream molded elements 20, 40.

The downstream filter medium body 32 is connected at one of its outer edges 38, 39, here at its downstream outer edge 38, by means of the circumferential downstream molded element 40 to the frame element 50.

As seen for example in FIG. 4, the frame element 50 comprises at its downstream end a collar 51 which is folded in lateral direction 82 outwardly and which is embedded in the downstream molded element 40. In this context, the collar 51, when the filter element 10 is inserted as intended in the filter housing 110, is compressed with the molded element 40 between the seal surface 126 and the end 128 of the housing wall 118.

The frame element 50 comprises in addition at its upstream end a circumferential rim 24 which comprises a groove 25 extending in axial direction 80 away from the downstream molded element 40. The groove 25 projects in this context into the interior of the frame element 50. The groove 25 is configured as an integrated mold for the upstream molded element 20.

When polyurethane (PUR) is used, for example, as a molding material for the molded element 20, polyamide (PA) may be used as a plastic material for the frame element 50 in order to ensure a good attachment of the molded element 20 at the groove 25.

As seen in FIG. 4, the molded element 20 fills the groove 25. A portion of the outermost folds 22 of the upstream filter medium body 12 are in this way connected to the molded element 20.

The upstream filter medium body 12 projects in this context in axial direction 80 largely out of the frame element 50 and is embedded with its downstream outer edge 18 in the upstream molded element 20.

The downstream molded element 40 is configured as an axial seal element for sealing between the raw side 60 and the clean side 62. The molded element 40 in this context is arranged radially outside of the filter medium bodies 12, 32 and seals at the same time between the first housing part 112 and the second housing part 114. A seal surface 126 of the first housing part 112 contacts the molded element 40, and the housing wall 118 of the second housing part 114 is seal-tightly pressed against the molded element 40 at a side of the molded element 40 facing away from the seal surface 126.

The frame element 50 in the region of the upstream and/or downstream mold element 20, 40 may comprise gaps, not illustrated, at its circumference for interlocking with the molding material.

Between the outermost upstream and the outermost downstream filter medium bodies 12, 32, a reinforcement element 30 is arranged areally. The reinforcement element 30 in the illustrated embodiment is configured as an expansive reinforcement grid. As an alternative or in addition, the filter medium bodies 12, 32 may also be reinforced by one or a plurality of glue beads.

The reinforcement element 30 may be supported at the frame element 50. Optionally, the reinforcement element 30 may also be connected to the frame element 50, for example it may be configured as one piece together with the frame element 50.

As seen further in FIG. 4, one of the filter medium bodies 32 comprises a circumferential lateral strip 48 at its outer circumference 46 for lateral sealing of the filter medium body 32, which strip is embedded at least partially in the correlated molded element 40.

The lateral strip 48, for example, may be configured of a nonwoven material, for example a filter nonwoven, filter fabric or laid filter material. The nonwoven material of the lateral strip 48 may comprise for example a reduced air permeability compared to a filter medium of the filter medium body 32 and/or a higher bending stiffness compared to a filter medium of the filter medium body 32.

At its outflow side 44, the downstream filter medium body 32 comprises an additional filter layer 56. In this context, the additional filter layer 56 is embedded at least partially in the downstream molded element 40. As embodiments for the additional filter layer 56, filter media on the basis of cellulose fibers and/or synthetic fibers, for example nonwoven materials, and/or filter membranes are conceivable.

In the section view of FIG. 4, it may also be seen how the screw tab 58 of the frame element 50 is arranged between the screw sleeve 124 of the housing wall 118 of the second housing part 114 and the housing-side screw tab 120 of the housing wall 116 of the first housing part 112 and fastened by means of the screw 122. In this way, the filter element 10 is fixedly secured in the filter housing 110 and the two housing parts 112, 114 of the filter housing 110 are fixedly closed and sealed by means of the downstream molded element 40.

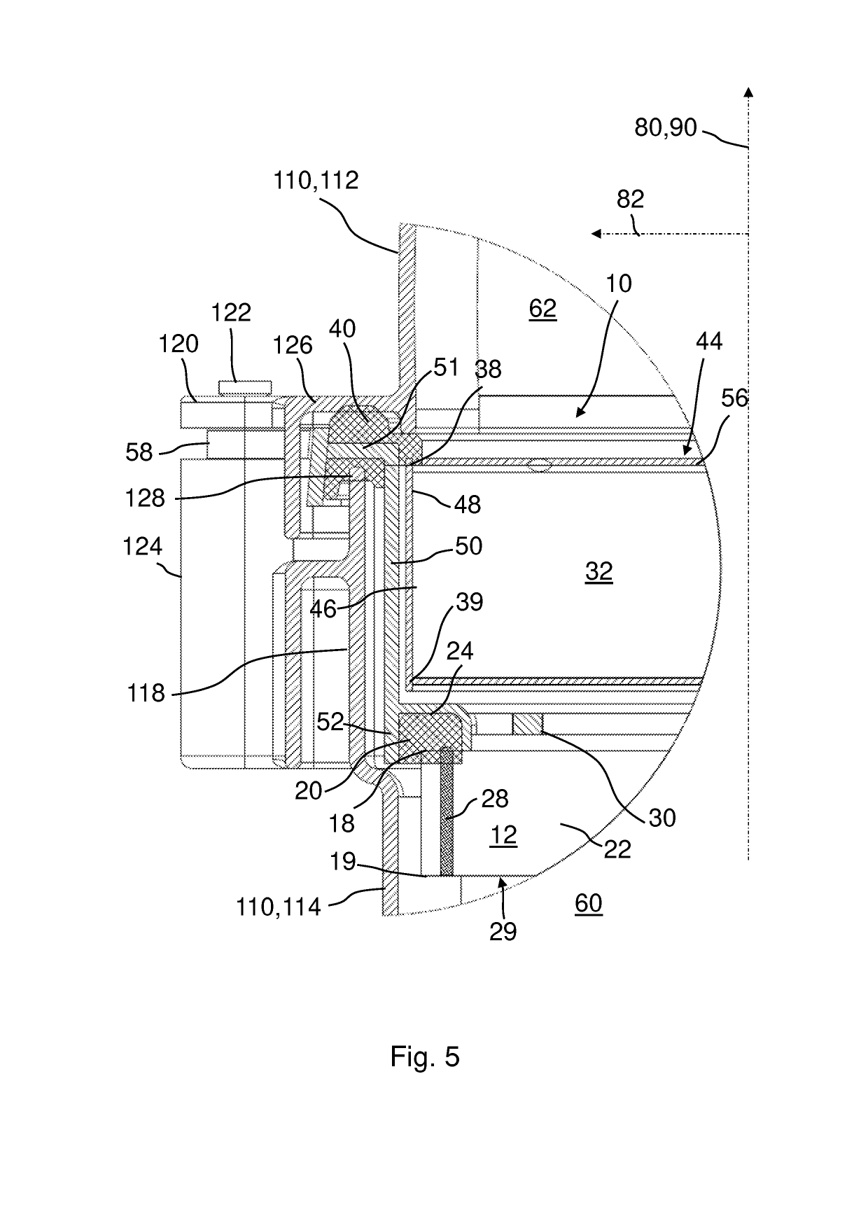

FIG. 5 shows an enlarged detail of a section view of a filter system 100 according to a further embodiment of the invention.

In this embodiment, end face edges 23 of the folds 22 of the upstream filter medium body 12 are sealed by an end face edge bonding 28. The individual folds 22 cannot be seen in this illustration because they extend perpendicularly to the image plane. The end face edge bonding 28 at the outer edge 18 of the filter medium body 12 is at least partially embedded in the upstream molded element 20.

The downstream filter medium body 32 is configured as in the embodiment illustrated in FIGS. 3 and 4.

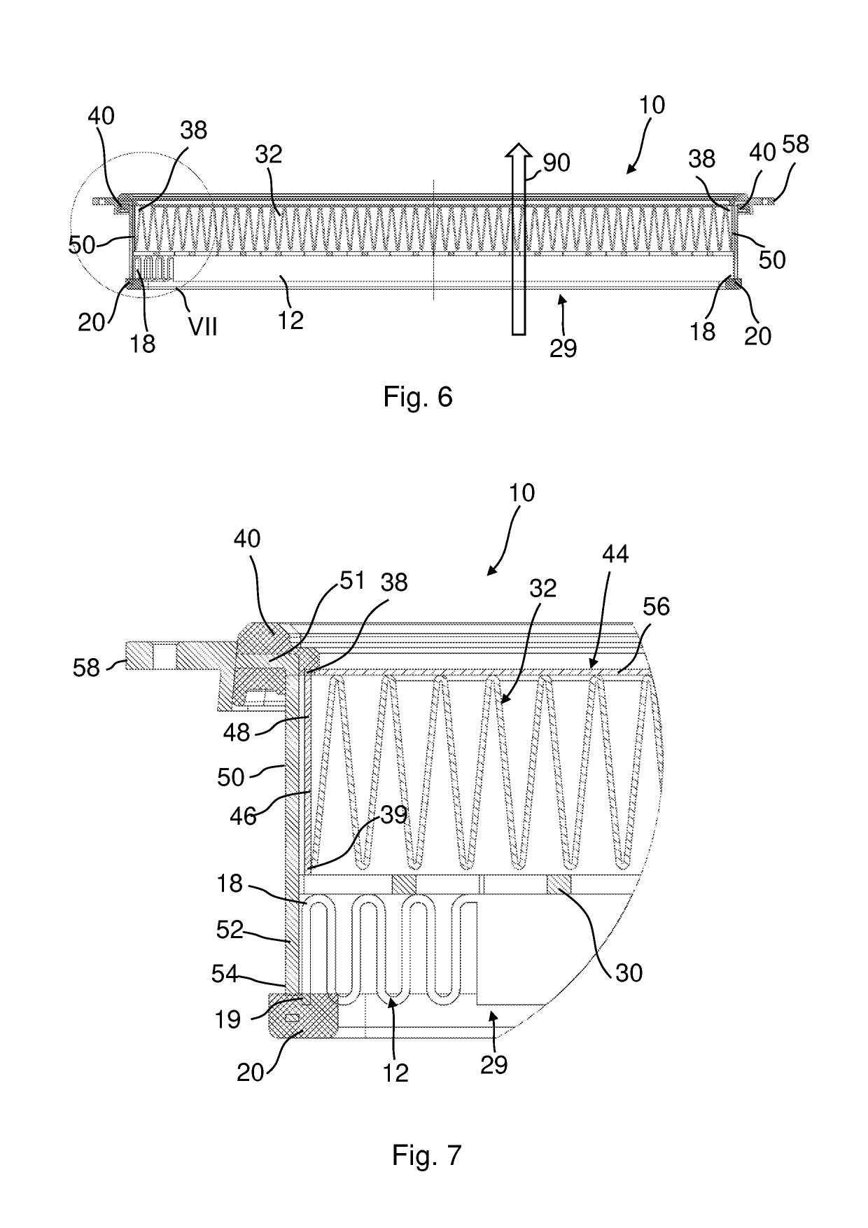

FIG. 6 shows a longitudinal section of a filter element 10 according to a further embodiment of the invention with the marked detail VII. Details are illustrated in the enlarged detail VII of FIG. 7.

The illustrated embodiment differs from the embodiments in FIGS. 3 to 5 essentially in regard to the connection of the upstream filter medium body 12. The wall 52 of the frame element 50 is in this context extended so that the upstream filter medium body 12 in axial direction 80 projects largely into the frame element 50. At the axial end 54 of the wall 52, the upstream molded element 20 is arranged. In this context, the filter medium body 12 is embedded with its upstream outer edge 19 in the upstream molded element 20.

In this embodiment, an optional reinforcement element 30 may also be arranged between the two filter medium bodies 12, 32, as illustrated.

### REFERENCE CHARACTERS

10 filter element

12 filter medium body

18 outer edge

19 outer edge

20 upstream molded element

22 fold

23 end face edge

24 rim

25 groove

28 end face edge bonding

29 inflow side

30 reinforcement grid

32 filter medium body

38 outer edge

39 outer edge

40 downstream molded element

44 outflow side

46 outer circumference

48 lateral strip

50 frame element

51 collar

52 wall

54 axial end

56 filter layer

58 screw tab

60 raw side

62 clean side

80 axial direction

82 lateral direction

90 flow direction

100 filter system

102 fluid inlet

104 fluid outlet

110 filter housing

112 first housing part

114 second housing part

116 housing wall

118 housing wall

120 screw tab

122 screw

124 screw sleeve

126 seal surface

128 end

That which is claimed is:

1. A flat-filter filter element for filtering a fluid, the flat-filter filter element comprising:
at least two areal filter medium bodies arranged in an axial direction adjacent to each other and arranged to be flowed through by the fluid sequentially in the axial direction;
wherein the at least two areal filter medium bodies include an outermost downstream filter medium body and an outermost upstream filter medium body,
a circumferential frame element;
wherein the outermost downstream filter medium body and the outermost upstream filter medium body are arranged at least partially in the axial direction radially inside the circumferential frame element;
wherein the outermost downstream filter medium body comprises a circumferential downstream molded element, and wherein the outermost downstream filter medium body is connected by the circumferential downstream molded element to the circumferential frame element;
wherein the outermost upstream filter medium body comprises a circumferential upstream molded element, and wherein the outermost upstream filter medium body is connected by the circumferential upstream molded element to the circumferential frame element;
wherein the circumferential upstream molded element is connected to an upstream end of the circumferential frame element and wherein the circumferential downstream molded element is connected to a downstream end of the circumferential frame element.

2. The flat-filter filter element according to claim 1, wherein an outer edge of the outermost downstream filter medium body is connected by the circumferential downstream molded element to the circumferential frame element.

3. The flat-filter filter element according to claim 1, wherein the downstream end of the circumferential frame element is enclosed at least partially by the circumferential downstream molded element and/or wherein the upstream end of the circumferential frame element is enclosed at least partially by the circumferential upstream molded element.

4. The flat-filter filter element according to claim 1, wherein the downstream end of the circumferential frame element comprises an outwardly folded collar.

5. The flat-filter filter element according to claim 4, wherein the outwardly folded collar is embedded in the circumferential downstream molded element.

6. The flat-filter filter element according to claim 1, wherein the upstream end of the circumferential frame element comprises a circumferential rim, wherein the circumferential rim comprises a groove facing away in the axial direction from the circumferential downstream molded element.

7. The flat-filter filter element according to claim 6, wherein the groove is configured as an integrated mold for the circumferential upstream molded element.

8. The flat-filter filter element according to claim 6, wherein the groove
projects into an interior of the circumferential frame element.

9. The flat-filter filter element according to claim 1, wherein the outermost upstream filter medium body projects in the axial direction out of the circumferential frame element and comprises a downstream outer edge embedded in the circumferential upstream molded element.

10. The flat-filter filter element according to claim 1, wherein the outermost upstream filter medium body projects in the axial direction into the circumferential frame element and comprises an upstream outer edge embedded in the circumferential upstream molded element.

11. The flat-filter filter element according to claim 1, further comprising at least one reinforcement element areally arranged between the outermost upstream filter medium body and the outermost downstream filter medium body.

12. The flat-filter filter element according to claim 1, wherein at least one of the outermost upstream filter medium body and of the outermost downstream filter medium body comprises a lateral strip surrounding an outer circumference of the at least one of the outermost upstream filter medium body and of the outermost downstream filter medium body, and wherein the lateral strip is embedded at least partially in the respective circumferential upstream molded element or circumferential downstream molded element.

13. The flat-filter filter element according to claim 1, further comprising an additional filter layer arranged at an outflow side of the outermost downstream filter medium body, and wherein the additional filter layer is embedded at least partially in the circumferential downstream molded element.

14. The flat-filter filter element according to claim 1, wherein the outermost upstream filter medium body is a particle filter and/or the outermost downstream filter medium body is an adsorption filter.

15. The flat-filter filter element according to claim 1, wherein the circumferential downstream molded element is a seal element configured to seal between a raw side and a clean side in a filter housing when the flat-filter filter element is installed in the filter housing.

16. The flat-filter filter element according to claim 15, wherein the circumferential downstream molded element is arranged radially outside of the at least two areal filter medium bodies and is configured to seal between a first housing part and a second housing part of the filter housing.

17. The flat-filter filter element according to claim 1, wherein at least one of the outermost downstream filter medium body and of the outermost upstream filter medium body is configured as a folded filter bellows, wherein end face edges of folds of the folded filter bellows are sealed by an end face edge bonding, and wherein the end face edge bonding is embedded at least partially in the respective circumferential downstream molded element or the respective circumferential upstream molded element.

18. A filter system for filtering a fluid, the filter system comprising:
a filter housing with a fluid inlet and a fluid outlet;
a flat-filter filter element according to claim 1, wherein the flat-filter filter element is arranged between the fluid inlet and the fluid outlet;
wherein the filter housing comprises a first housing part comprising a seal surface and further comprises a second housing part comprising a housing wall;
wherein the seal surface of the first housing part contacts the circumferential downstream molded element of the flat-filter filter element;
wherein the housing wall of the second housing part is pressed seal-tightly against the circumferential downstream molded element at a side of the circumferential downstream molded element facing away from the seal surface.

19. The filter system according to claim 18, wherein the circumferential frame element of the flat-filter filter element comprises a collar which extends in a lateral direction and is embedded in the circumferential downstream molded element, and wherein the collar together with the circumferential downstream molded element is compressed between the seal surface of the first housing part and an end of the housing wall of the second housing part.

20. The filter system according to claim 18, wherein the filter system is an air filter system of a fuel cell system.
